(19) United States
(12) Patent Application Publication
(10) Pub. No.: US 2022/0140725 A1
(43) Pub. Date: May 5, 2022

(54) ENERGY-ABSORBING CIRCUITS

(71) Applicant: Hewlett-Packard Development Company, L.P., Spring, TX (US)

(72) Inventors: Te-Yueh Lin, Taipei City (TW); Chin-Ho Li, Taipei City (TW)

(73) Assignee: Hewlett-Packard Development Company, L.P., Spring, TX (US)

(21) Appl. No.: 17/297,365

(22) PCT Filed: Jul. 19, 2019
(86) PCT No.: PCT/US2019/042685

§ 371 Date: May 26, 2021

(51) Int. Cl. H02M 1/34; H02M 1/00

(52) U.S. Cl. CPC H02M 1/34; H02M 1/344; H02M 1/0009

(57) ABSTRACT

An example electronic device is described. The electronic device includes a voltage converter and a switching circuit. The switching circuit includes a first switch to couple a first energy-absorbing circuit to the voltage converter to decrease a voltage spike generated during operation of the voltage converter when a value of an output current of the voltage converter is in a first current range. The switching circuit further includes a second switch to couple a second energy-absorbing circuit to the voltage converter to decrease the voltage spike, when the value of the output current is in a second current range.

### BACKGROUND

Energy-absorbing circuits are used in a power supply unit of an electronic device to reduce noise, such as voltage spikes and oscillations, generated during operation of one or more components of the power supply unit. For instance, during switching operation of a voltage converter used in the power supply unit, energy may get stored in inductors used in the voltage converter. Due to energy stored in inductors, resonance may occur in the voltage converter. The resonance may result in generation of high-frequency noise, such as voltage spike, causing damage to components, such as diodes and inductors, of the voltage converter. The energy-absorbing circuits help in reducing the voltage spike by absorbing the energy accumulated in the inductors.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates an electronic device comprising a switching circuit to switch between a first energy-absorbing circuit and a second energy-absorbing circuit, according to an example of the present subject matter;

FIG. 2 illustrates an electronic device comprising a plurality of snubber circuits as energy-absorbing circuits, according to an example of the present subject matter;

FIG. 3 illustrates an electronic device comprising the switching circuit and a set of snubber circuits, according to an example of the present subject matter:

FIG. 4 illustrates a circuit diagram of a power supply unit comprising an energy-absorbing stage, according to an example of the present subject matter.

### DETAILED DESCRIPTION

Voltage converters may cause voltage spikes that may vary during the operation of the voltage converter. The voltage spike may further vary from one voltage converter to another. To reduce the voltage spike, energy-absorbing circuits, such as snubber circuits, are used. The reduction in the voltage spike may vary based on an impedance value of the snubber circuit. Thus, a snubber circuit of an appropriate impedance value has to be used for reducing a desired voltage spike. Using a snubber circuit having an impedance value greater than the appropriate value may lead to high power losses and heat generation during the operation of the voltage converter. Using a snubber circuit having an impedance value lower than the appropriate value may not be able to provide noise cancellation, thus affecting the performance of the voltage converter.

However, as the voltage spike gets generated during the operation of the voltage converter, an impedance value appropriate for reducing the voltage spike may be determined after the power supply unit having the voltage converter is fabricated. Thus, the voltage converter may not be able to operate efficiently if impedance value of the snubber circuit is either higher or lower than the impedance value appropriate for the voltage converter. Thus, the snubber circuit of the voltage converter may either be replaced or modified. Alternately, the voltage converter may be re-fabricated with a different snubber circuit. In one approach the snubber circuit is manually tested during fabrication of a voltage converter to determine the impedance value appropriate for absorbing noise from the voltage converter. Manually testing the snubber circuit for each voltage converter may be a time consuming and inefficient approach and may involve various iterations with different snubber circuits.

In another approach, the snubber circuit may include a variable resistor, a variable capacitor, and a controller. The controller may dynamically vary resistance and capacitance of the variable resistor and the variable capacitor in accordance to a voltage spike generated in the voltage converter connected to the snubber circuit. The controller may monitor the decrease in the voltage spike in accordance to the variance of the resistance and the capacitance and find out an appropriate resistance and capacitance (R-C) combination that can decrease the voltage spike. Such an approach may, however, effect the performance of the voltage converter as the voltage converter may get heated due to the voltage spike before the controller identifies the suitable R-C combination for providing the appropriate impedance. Further, the voltage converter may have to include a separate monitor to monitor the voltage spike.

The present subject matter discloses an energy-absorbing stage having a plurality of energy-absorbing circuits for decreasing voltage spike caused during operation of a voltage converter in an electronic device. In one example, different levels of voltage spikes may be associated with a corresponding value of output current obtained at the voltage converter during operation of the voltage converter. Based on the value of the output current, a switching circuit may connect one energy-absorbing circuit from among the plurality of energy-absorbing circuits with the voltage converter. In one example, the switching circuit may connect the energy-absorbing circuit having a voltage spike correction rating corresponding to the value of the output current. In one example, the voltage spike correction rating of an energy-absorbing circuit may indicate a range of output current for which the energy-absorbing circuit may decrease the voltage spike generated during operation of the voltage converter.

In accordance to an example implementation of the present subject matter, the energy-absorbing stage may be a snubber circuit stage having a plurality of snubber circuits. In one example, the plurality of snubber circuits may include a first snubber circuit and a second snubber circuit. The first snubber circuit may have a first impedance value and a voltage spike correction rating corresponding to a first current range. The second snubber circuit may have a second impedance value and a voltage spike correction rating corresponding to a second current range. In another example, the plurality of snubber circuits may include the first snubber circuit, the second snubber circuit, and a third snubber circuit. The third snubber circuit may have a third impedance value and a voltage spike correction rating corresponding to a third current range.

The electronic device may further include a controller to identify the snubber circuit having the voltage spike correction rating corresponding to the value of the output current. In one example, the controller may enable a switching circuit of the electronic device to connect the identified snubber circuit to the voltage converter to decrease the voltage spike. In one example, the controller may enable a first switch of the switching circuit to couple the first snubber circuit to the voltage converter if the value of the output current is in the first current range. Further, the controller may enable a second switch of the switching circuit to couple the second snubber circuit to the voltage converter if the value of the output current is in the second current range.

The present subject matter thus facilitates dynamic switching between snubber circuits of different voltage spike correction rating and impedance value to decrease the voltage spike in accordance with the output current across the voltage converter. Having a set of snubber circuits of different impedance values facilitates in reducing power losses, heat generation, and voltage spike as the snubber circuit with an impedance value appropriate for reducing the voltage spike may be selected and connected to the voltage converter. Further, since the different levels of voltage spike are associated with output current values and the switching between the snubber circuits is performed based on the output current value, the switching happens in a short duration. The voltage spike is thus efficiently and quickly decreased.

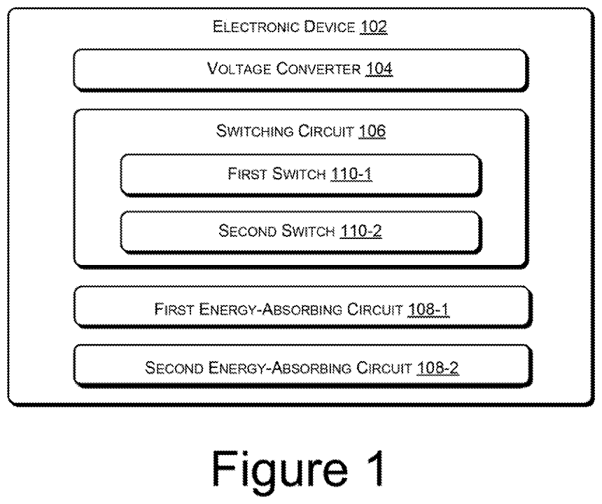

The present subject matter is further described with reference to FIGS. 1 to 4. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates an electronic device 102, according to an example of the present subject matter. In one example, the electronic device 102 may be a device that may operate upon Direct current (DC) power supply. Examples of the electronic device 102 include, but are not limited to, a laptop, a notebook, a tablet, a personal digital assistant, a phablet, a cellular communication device, a printing device, a scanning device, an all-in-one print device, and display devices. In accordance with an example implementation of the present subject matter, the electronic device 102 includes a voltage converter 104 for converting an input voltage to an output voltage to operate the electronic device 102. During the operation of the voltage converter 104, intermittent voltage spikes may be generated, which may be in accordance with the value of an output current of the voltage converter.

The electronic device 102 may further include a switching circuit 106 for switching between energy-absorbing circuits, for example, a first energy-absorbing circuit 108-1 and a second energy-absorbing circuit 108-2, to decrease the voltage spike. Examples of an energy-absorbing circuit include, but are not limited to, a snubber circuit, a thyristor circuit, and a MOSFET based energy-absorbing circuit. The first energy-absorbing circuit 108-1 and the second energy-absorbing circuit 108-2 are collectively referred to as the energy-absorbing circuits 108 and individually as energy-absorbing circuit 108. In one example, the switching circuit 106 may switch between the first energy-absorbing circuit 108-1 and the second energy-absorbing circuit 108-2 depending on the value of the output current of the voltage converter. In one example, the switching circuit 106 may include a first switch 110-1 to couple the first energy-absorbing circuit 108-1 to the voltage converter 104, to decrease the voltage spike, when the value of the output current is in a first current range. The switching circuit 106 may further include a second switch 110-2 to couple the second energy-absorbing circuit 108-2 to the voltage converter 104, to decrease the voltage spike, when the value of the output current is in a second current range.

In one example, the first energy-absorbing circuit 108-1 may have a first voltage spike correction rating equal to the first current range. The second energy-absorbing circuit 108-2 may have a second voltage spike correction rating equal to the second current range. Thus, one of the first energy-absorbing circuit 108-1 and the second energy-absorbing circuit 108-2 may be identified for decreasing the voltage spike based on the corresponding voltage spike correction rating. The identified energy-absorbing circuit 108 may be connected by the switching circuit 106 to the voltage converter 104. The switching circuit 106 may, thus, provide dynamic switching between the first energy-absorbing circuit 108-1 and the second energy-absorbing circuit 108-2 to decrease the voltage spike in accordance with the output current across the voltage converter 104.

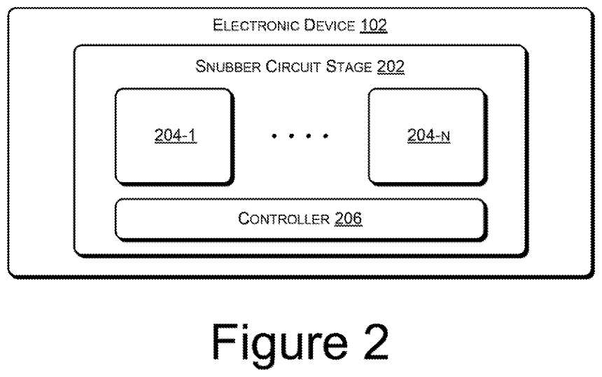

FIG. 2 illustrates an electronic device 102 comprising a plurality of snubber circuits as energy-absorbing circuits, according to an example of the present subject matter. The electronic device 102 includes a snubber circuit stage 202 to decrease a voltage spike generated during operation of a voltage converter, such as the voltage converter 104 of the electronic device 102. In one example, the snubber circuit stage 202 includes a plurality of snubber circuits 204-1, . . . , 204-n, hereinafter collectively referred to as snubber circuits 204 and individually as snubber circuit 204.

The snubber circuit stage 202 may further include a controller 206 to receive a value of an output current of the voltage converter 104, during the operation of the voltage converter 104. The controller 206 may identify a snubber circuit 204 from the amongst the plurality of snubber circuits 204 for connecting to the voltage converter 104 to decrease the voltage spike. In one example, the controller 206 may identify a snubber circuit 204 having a voltage spike correction rating corresponding to the value of the output current. In one example, the voltage spike correction rating of the snubber circuit 204 may indicate a range of output current for which the snubber circuit 204 may decrease the voltage spike. Upon receiving the value of the output current, the controller 206 may analyze a mapping table to identify the voltage spike correction rating apposite for correcting the voltage spike corresponding to the output current.

In one example, the mapping table may be stored in the controller 206 and may include a mapping between values of the output current and the voltage spike correction ratings. The controller 206 may identify the snubber circuit 204 having the identified voltage spike correction rating and enable the identified snubber circuit 204 to decrease the voltage spike generated during operation of the voltage converter 104. In one example, the controller 206 may operate a switch (not shown in this figure) be connected to the identified snubber circuit 204 to enable the identified snubber circuit to decrease the voltage spike. The switch may couple the snubber circuit 204 to the voltage converter to decrease the voltage spike. The controller 206 may, thus, provide dynamic switching between the plurality of snubber circuits 204 to decrease the voltage spike in accordance with the output current across the voltage converter 104.

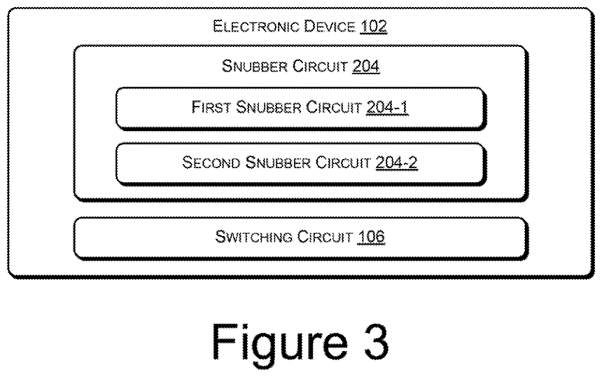

FIG. 3 illustrates an electronic device 102 comprising a switching circuit 106 and a set of snubber circuits, such as the snubber circuits 204, according to an example of the present subject matter. In one example, the set of snubber circuits 204 includes a first snubber circuit 204-1 and a second snubber circuit 204-2. The electronic device 102 may further include the switching circuit 106 to selectively connect the first snubber circuit 204-1 or the second snubber circuit 204-2 to the voltage converter 104 to decrease the voltage spike. In one example, the switching circuit 106 may selectively connect the first snubber circuit 204-1 or the second snubber circuit 204-2 to the voltage converter 104 based on the value of the output current of the voltage converter 104.

In one example, one of the first snubber circuit 204-1 and the second snubber circuit 204-2 may be identified for being connected to the voltage converter based on a corresponding voltage spike correction rating. For instance, the first snubber circuit 204-1 may have a first voltage spike correction rating equal to a first current range. The second snubber circuit 204-2 may have a second voltage spike correction rating equal to a second current range. Thus, the switching circuit 106 may connect the first snubber circuit 204-1 to the voltage converter 104 if the output current is in the first current range. Similarly, the switching circuit 106 may connect the second snubber circuit 204-2 to the voltage converter 104 if the output current is in the second current range, thus, providing a dynamic switching between the first snubber circuit 204-1 and the second snubber circuit 204-2 to decrease the voltage spike.

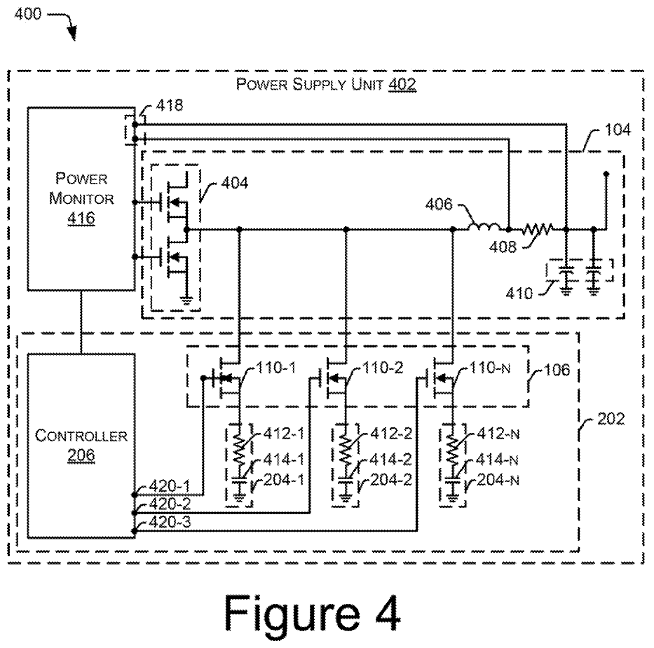

FIG. 4 illustrates a circuit diagram 400 of a power supply unit 402 of an electronic device 102 comprising the snubber circuit stage 202 as an energy-absorbing stage, according to an example of the present subject matter. As previously described, the electronic device 102 may be a device, such as a laptop, a notebook, a tablet, a personal digital assistant, a phablet, a cellular communication device, a printing device, a scanning device, an all-in-one print device, and display devices, that may operate upon DC power supply. The electronic device 102 includes the power supply unit 402 to control power supply provided to the electronic device 102 from external and internal power sources.

The power supply unit 402 may further include the voltage converter 104 to convert an input voltage of the power supply to an output voltage as per a voltage rating of the electronic device 102. In one example, the voltage converter 104 may be a PWM voltage regulator and may include various components, such as a MOSFET circuitry 404, an inductor 406, a resistor 408, capacitors 410, and other additional components not shown in the FIG. 4, to perform various functionalities during operation of the voltage converter 104. Further, intermittent voltage spikes may be generated during the operation of the voltage converter 104, affecting the working of the voltage converter 104 and the various components of the voltage converter 104. The voltage spike may vary in accordance with an output load and in turn the value of the output current obtained at the voltage converter 104 may vary during operation of the voltage converter 104. In one example, the output current may be divided into multiple ranges and the voltage spike may be accordingly divided into various levels to be associated with respective one of the multiple ranges of output current. For instance, the output current may be divided into two ranges and the voltage spike may be correspondingly divided into two levels. In another example, the output current may be divided into four ranges and the voltage spike may be correspondingly divided into four levels.

In one example, for the output current in a first current range, the voltage converter 104 may experience a first level of voltage spike. For the output current in a second current range, the voltage converter 104 may experience a second level of voltage spike. For the output current in a third current range, the voltage converter 104 may experience a third level of voltage spike. In one example, the first level of spike may be a mild voltage spike, the second level of voltage spike may be a moderate voltage spike, the third level of voltage spike may be a high voltage spike.

Further, the first current range may be, for example, between 1-3 Ampere (A), the second current range may be, for example, between 4-6 A, the third current range may be, for example, 7 A and above. In another example, the first current range may be between 2-5 Ampere (A), the second current range may be between 6-9 A, the third current range may be 9 A and above. In yet another example, the first current range may be between 5-9 Ampere (A), the second current range may be between 10-14 A, the third current range may be 15 A and above.

The power supply unit 402 of the electronic device 102 may further include the snubber circuit stage 202 as the energy-absorbing stage to decrease the voltage spike generated during operation of the voltage converter. Further, the snubber circuit stage 202 may include a plurality of snubber circuits 204-1, . . . , 204-n to decrease the voltage spike. In one example, the number of snubber circuits 204 may vary depending on the number of current ranges into which the output current has been divided. In one example, the snubber circuit stage 202 may include the first snubber circuit 204-1 and the second snubber circuit 204-2 to decrease the voltage spike corresponding to the first range of output current and the second range of output current, respectively. In another example, the snubber circuit stage 202 may include the first snubber circuit 204-1, the second snubber circuit 204-2, and a third snubber circuit 204-n to decrease the voltage spike corresponding to the first range of output current, the second range of output current, and the third range of output current, respectively.

Although the description herein is provided with reference to a snubber circuit stage having three snubber circuits, snubber circuit stages with additional snubber circuits or two snubber circuits may be utilized for decreasing the voltage spike, albeit with a few variations.

In one example implementation, the first snubber circuit 204-1 may have a first impedance value and may include a first resistor 412-1 having a first resistance value and a first capacitor 414-1 having a first capacitance value. The resistance value and the capacitance value of the first resistor 412-1 and the first capacitor 414-1 may be chosen such that the first snubber circuit 204-1 has a first impedance value and is thus operable to decrease the voltage spike generated when the output current is in the first current range. Thus, the first snubber circuit 204-1 may have a first voltage spike correction rating corresponding to the first current range.

The second snubber circuit 204-2 may have a second impedance value and may include a second resistor 412-2 having a second resistance value and a second capacitor 414-2 having a second capacitance value. The resistance value and the capacitance value of the second resistor 412-2 and the second capacitor 414-2 may be chosen such that the second snubber circuit 204-2 has the second impedance value and is thus operable to decrease the voltage spike generated when the output current is in the second current range. Thus, the second snubber circuit 204-2 may have a second voltage spike correction rating corresponding to the second current range.

The third snubber circuit 204-n may have a third impedance value and may include a third resistor 412-3 having a third resistance value and a third capacitor 414-n having a third capacitance value. The resistance value and the capacitance value of the third resistor 412-3 and the third capacitor 414-n may be chosen such that the third snubber circuit 204-n has the third impedance value and is thus operable to decrease the voltage spike generated when the output current is in the third current range. Thus, the third snubber circuit 204-n may have a third voltage spike correction rating corresponding to the third current range. Other snubber circuits, when included, may have a particular impedance value and may include a resistor and a capacitor.

In one example, if the first current range is in between 5-9 A, the first resistor 412-1 may have the first resistance value equal to 1.1 ohm and the first capacitor 414-1 may have the first capacitance value equal to 1 nanofarad (nF). If the second current range is in between 10-14 A, the second resistor 412-2 may have the second resistance value equal to 2.2 ohm and the second capacitor 414-2 may have the second capacitance value equal to 3 nF. If the third current range is 15 A and above, the third resistor 412-n may have the third resistance value equal to 3.3 ohm and the third capacitor 414-n may have the third capacitance value equal to 10 nF.

Thus, based on the value of the output current, the snubber circuit 204 having the corresponding voltage spike correction rating may be identified from the snubber circuits 204 for decreasing the voltage spike. For this, in one example, the snubber circuit stage 202 may further include the controller 206 and the switching circuit 106 connected to the controller 206 and the snubber circuits 204. The controller 206 is to identify the snubber circuit 204 having the voltage spike correction rating corresponding to the value of the output current. The switching circuit 106 is to connect the identified snubber circuit 204 to the voltage converter 104 to decrease the voltage spike. The switching circuit 106 may include a plurality of switches 110, such that for the snubber circuit 204 there is a corresponding switch 110 to enable or disable the snubber circuit 204. In one example, the switching circuit 106 as illustrated in FIG. 4 may include the first switch 110-1, the second switch 110-2, and a third switch 110-n. In one example, the first switch 110-1, the second switch 110-2, and the third switch 110-n may be MOSFETs that may be enabled by the controller 206, by providing a high input current, to switch the corresponding snubber circuit ON.

The first switch 110-1 may be coupled to the controller 206 and the first snubber circuit 204-1 to connect the first snubber circuit 204-1 to the voltage converter 104, when the first snubber circuit 204-1 is the identified snubber circuit. The second switch 110-2 may be coupled to the controller 206 and the second snubber circuit 204-2 to connect the second snubber circuit 204-2 to the voltage converter 104, when the second snubber circuit 204-2 is the identified snubber circuit. The third switch 110-n may be coupled to the controller 206 and the third snubber circuit 204-n to connect the third snubber circuit 204-n to the voltage converter 104, when the third snubber circuit 204-n is the identified snubber circuit.

Thus, when the value of the output current range is in the first current range, the first switch 110-1 may connect the first snubber circuit 204-1 to the voltage converter 104, while the second switch 110-2 and the third switch 110-n may keep the second snubber circuit 204-2 and the third snubber circuit 204-n open, i.e., disconnected from the voltage converter 104. Similarly, when the value of the output current range is in the second current range, the second switch 110-2 may connect the second snubber circuit 204-2 to the voltage converter 104, while the first switch 110-1 and the third switch 110-n may keep the first snubber circuit 204-1 and the third snubber circuit 204-n open, i.e., disconnected from the voltage converter 104. The switching circuit 106 may thus selectively connect the first snubber circuit 204-1, the second snubber circuit 204-2, or the third snubber circuit 204-n to the voltage converter 104 using the first switch 110-1, the second switch 110-2, and the third switch 110-n to decrease the voltage spike, based on the value of the output current.

The power supply unit 402 may further include a power monitor 416 electrically coupled to the voltage converter 104 to ascertain the value of the output current. In one example, the power monitor 416 may include current sensing pins 418 for connecting to the voltage converter 104 to continuously monitor the output current of the voltage converter 104 to detect the value of the output current. The power monitor 416 may then generate a data signal indicating the value of the output current and transmit the data signal to the controller 206. Further, upon detecting a change in the value of the output current, the power monitor 416 may generate a new data signal indicating the new value of the output current and transmit the new data signal to the controller 206.

In operation, once the electronic device 102 is switched ON, the power supply unit 402, and in turn the voltage converter 104, may start operating. As the voltage converter 104 starts operating, the power monitor 416 may determine the value of the output current and transmit the data signal indicating the value of the output current to the controller 206. The controller 206 may receive the data signal having the value of the output current. In response to receiving the data signal, the controller 206 may identify the snubber circuit 204 having the voltage spike correction rating corresponding to the value of the output current.

In one example, the controller 206 may identify the snubber circuit 204 having the voltage spike correction rating corresponding to the value of the output current using a mapping table. The mapping table may include a mapping between values of the output current and the voltage spike correction ratings of the snubber circuits. The mapping table may further include a mapping between the voltage spike correction ratings and the snubber circuits 204. The controller 206 may initially analyze the data signal to obtain the value of the output current. The controller 206 may further analyze the mapping table to identify the voltage spike correction rating corresponding to the value of the output current. The controller 206 may further identify the corresponding snubber circuit 204 having the identified voltage spike correction rating, based on the mapping table. The controller 206 may then enable the identified snubber circuit 204 to decrease the voltage spike.

For instance, if the output current has the value falling in the first current range, for example, 5 A, the controller 206 may identify the first snubber circuit 204-1 having the first voltage spike correction rating corresponding to the value of the output current for decreasing the voltage spike. The controller 206 may then enable the first snubber circuit 204-1.

To enable the identified snubber circuit, the controller 206 may generate a switching signal instructing the switching circuit 106 to connect the identified snubber circuit 204 to the voltage converter 104. The controller 206 may transmit the switching signal to the switch 110 corresponding to the identified snubber circuit 204 for switching ON the identified snubber circuit 204. In one example, the switch 110 may be connected to a General-Purpose Input/Output (GPIO) pin of the controller 206 for receiving the switching signal. In one example, the first switch 110-1 may be connected to a first GPIO pin 420-1, the second switch 110-2 may be connected to a second GPIO pin 420-2, and the third switch 110-n may be connected to a third GPIO pin 420-n. The first GPIO pin 420-1, the second GPIO pin 420-2, and the third GPIO pin 420-n are collectively referred to as GPIO pins 420 and individually as GPIO pin 420.

Thus, to connect the identified snubber circuit 204 to the voltage converter 104, the controller 206 may transmit the switching signal to the corresponding switch 110. In one example, the controller 206 may provide a high level current, as the switching signal, at the GPIO pin 420 corresponding to the switch 110 to enable the switch 110 to connect the corresponding snubber circuit 204 to the voltage converter 104. Further, in absence of any current from the controller 206, the other GPIO pins 420 may keep the corresponding switches 110 and the snubber circuits 204 open while the identified snubber circuit 204 is connected to the voltage converter 104.

For example, in case the first snubber circuit 204-1 is identified to have the voltage spike correction rating corresponding to the value of the output current, the controller 206 may transmit high level current at the first GPIO pin 420-1 to enable the first switch 110-1. On receiving the switching signal, the first switch 110-1 may connect the first snubber circuit 204-1 to the voltage converter 104, as illustrated in FIG. 4. Further, the second switch 110-2 and the third switch 110-n may keep the second snubber circuit 204-2 and the third snubber circuit 204-n disconnected, as illustrated in FIG. 4. An operating impedance value of the snubber circuit stage 202 may be thus made equal to the first impedance value for decreasing the voltage spike.

Similarly, if the output current is in the second current range, the controller 206 may transmit high level current at the second GPIO pin 420-2 to enable the second switch 110-2. On receiving the switching signal, the second switch 110-2 may connect the second snubber circuit 204-2 to the voltage converter 104. Further, the first switch 110-1 and the third switch 110-n may keep the first snubber circuit 204-1 and the third snubber circuit 204-n disconnected. The operating impedance value of the snubber circuit stage 202 may be thus made equal to the second impedance value for decreasing the voltage spike. Further, for the output current being in the third current range, the third switch 110-n may receive the switching signal and connect the third snubber circuit 204-n to the voltage converter 104. Further, the first switch 110-1 and the second switch 110-2 may keep the first snubber circuit 204-1 and the second snubber circuit 204-2 disconnected.

Although the description herein is provided with reference to a snubber circuit stage having snubber circuits, other energy-absorbing stages having energy-absorbing circuits, such as a thyristor circuit and a MOSFET based energy-absorbing circuit, may be utilized, albeit with a few variations. For instance, an energy-absorbing stage having the first energy-absorbing circuit 108-1 and the second energy-absorbing circuit 108-2 may be utilized in place of the snubber circuit stage 202. In such a case, the first energy-absorbing circuit 108-1 may have a first voltage spike correction rating equal to the first current range. The second energy-absorbing circuit 108-2 may have a second voltage spike correction rating equal to the second current range.

Further, when the value of the output current is in the first current range, the controller 206 may identify the first energy-absorbing circuit 108-1 as the energy-absorbing circuit having the voltage spike correction rating equal to the output current. The first switch 110-1 may thus couple the first energy-absorbing circuit 108-1 to the voltage converter 104 to decrease the voltage spike. When the value of the output current is in the second current range, the controller 206 may identify the second energy-absorbing circuit 108-2 as the energy-absorbing circuit having the voltage spike correction rating equal to the output current. The second switch 110-2 may subsequently couple the second energy-absorbing circuit 108-2 to the voltage converter 104 to decrease the voltage spike when the value of the output current is in the second current range.

In one example, the energy-absorbing stage may include a third energy-absorbing circuit (not shown in the figures), having the third voltage spike correction rating equal to the third current range. The third switch 110-n may thus couple the third energy-absorbing circuit to the voltage converter 104 to decrease the voltage spike when the output current is in the third current range.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. An electronic device comprising:
a voltage converter; and
a switching circuit comprising:
a first switch to couple a first energy-absorbing circuit to the voltage converter to decrease a voltage spike generated during operation of the voltage converter, when a value of an output current of the voltage converter is in a first current range; and
a second switch to couple a second energy-absorbing circuit to the voltage converter to decrease the voltage spike, when the value of the output current is in a second current range.

2. The electronic device as claimed in claim 1, wherein the electronic device comprises a set of energy-absorbing circuits to decrease a voltage spike generated during operation of the voltage converter, the set of energy-absorbing circuits comprising:
the first energy-absorbing circuit having a first voltage spike correction rating equal to the first current range; and
the second energy-absorbing circuit having a second voltage spike correction rating equal to the second current range.

3. The electronic device as claimed in claim 1, further comprising a controller connected to the switching circuit to:
receive a data signal indicating the value of the output current of the voltage converter;
identify, from the amongst the first energy-absorbing circuit and the second energy-absorbing circuit, an energy-absorbing circuit having a voltage spike correction rating corresponding to the value of the output current; and
generate a switching signal instructing the switching circuit to connect the identified energy-absorbing circuit to the voltage converter.

4. The electronic device as claimed in claim 3, further comprising:
a third energy-absorbing circuit having a third voltage spike correction rating equal to a third current range, wherein the third energy-absorbing circuit is to decrease the voltage spike when the output current of the voltage converter is in the third current range; and
the switching circuit comprising a third switch connected to the controller to couple the third energy-absorbing circuit to the voltage converter to decrease the voltage spike when the output current of the voltage converter is in the third current range.

5. The electronic device as claimed in claim 1, further comprising a power monitor electrically coupled to the voltage converter to:
monitor the output current of the voltage converter;
detect a change in the value of the output current; and
generate a data signal indicating the value of the output current.

6. An electronic device comprising:
a snubber circuit stage, the snubber circuit stage comprising:
a plurality of snubber circuits; and
a controller to:
receive a value of an output current of a voltage converter of the electronic device;
identify, from amongst the plurality of snubber circuits, a snubber circuit having a voltage spike correction rating corresponding to the value of the output current; and
enable the identified snubber circuit to decrease a voltage spike generated during an operation of the voltage converter.

7. The electronic device as claimed in claim 6, further comprising a switching circuit to:
receive a switching signal from the controller to enable the identified snubber circuit; and
connect the identified snubber circuit to the voltage converter to decrease the voltage spike.

8. The electronic device as claimed in claim 7, wherein the switching circuit comprises:
a first switch to connect a first snubber circuit, from the plurality of snubber circuits, to the voltage converter, when the first snubber circuit is the identified snubber circuit;
a second switch to connect a second snubber circuit, from the plurality of snubber circuits, to the voltage converter, when the second snubber circuit is the identified snubber circuit; and
a third switch to connect a third snubber circuit, from the plurality of snubber circuits, to the voltage converter, when the third snubber circuit is the identified snubber circuit.

9. The electronic device as claimed in claim 6, further comprising a power monitor electrically coupled to the voltage converter to:
monitor the output current of the voltage converter;
detect a change in the value of the output current; and
generate a data signal indicating the value of the output current.

10. An electronic device comprising:
a set of snubber circuits to decrease a voltage spike generated during operation of a voltage converter of the electronic device, the set of snubber circuits comprising:
a first snubber circuit; and
a second snubber circuit; and
a switching circuit to selectively connect the first snubber circuit or the second snubber circuit to the voltage converter based on a value of an output current of the voltage converter.

11. The electronic device as claimed in claim 10, further comprising a power monitor electrically coupled to the voltage converter to:
monitor the output current of the voltage converter;
detect a change in the value of the output current; and
generate a data signal indicating the value of the output current.

12. The electronic device as claimed in claim 10, further comprising:
a controller to:
in response to receiving a data signal indicating the value of the output current, identify, from the amongst the set of snubber circuits, a snubber circuit having a voltage spike correction rating corresponding to the value of the output current; and
generate a switching signal instructing the switching circuit to connect the identified snubber circuit to the voltage converter.

13. The electronic device as claimed in claim 12, wherein the controller is to:
analyze the data signal to obtain the value of the output current;
analyze a mapping table to identify the voltage spike correction rating corresponding to the value of the output current; and
identify the snubber circuit having the identified voltage spike correction rating, based on the mapping table.

14. The electronic device as claimed in claim 12, wherein the switching circuit comprises:
a first switch connected to the controller to:
receive the switching signal when the first snubber circuit is the identified snubber circuit; and
connect the first snubber circuit to the voltage converter; and
a second switch connected to the controller to:
receive the switching signal when the second snubber circuit is the identified snubber circuit; and
connect the second snubber circuit to the voltage converter.

15. The electronic device as claimed in claim 14, wherein the switching circuit comprises a third switch connected to the controller to:
receive the switching signal when a third snubber circuit is the identified snubber circuit, from among the set of snubber circuits, when a voltage spike correction rating of the third snubber circuit corresponds to the value of the output current; and
connect the third snubber circuit to the voltage converter.
